(19) United States
(12) Patent Application Publication
(10) Pub. No.: US 2006/0239603 A1
(43) Pub. Date: Oct. 26, 2006

(54) Distributed sensor system coupled with a plurality of secondary sensors

(75) Inventors: Jayantilal S. Patel, Newtown, PA (US); Zhizhong Zhuang, Bensalem, PA (US); Yuri Zadorozhny, Morrisville, PA (US); Young Jin Kim, Woodstock, MD (US)

Correspondence Address: Young Jin Kim;Suite 100, 2260 Cabot Blvd West, Langhorne, PA, 19047, US

(73) Assignee: Optellios Inc., Langhorne, PA (US)

(21) Appl. No.: 11/151,334

(22) Filed: Jun. 13, 2005

Related U.S. Application Data
(60) Provisional application No. 60/674,267, filed on Apr. 22, 2005.

(51) Int. Cl. G02B 6/00

(52) U.S. Cl. 385/12

(57) ABSTRACT

An intrusion detection system with a distributed sensor system coupled with a plurality of secondary sensors is disclosed. The distributed sensor is deployed over a protected zone, and detects physical disturbances caused by intrusion into the zone. A plurality of physical disturbing devices is coupled to the distributed sensor to physically disturb the distributed sensor. A plurality of secondary sensors is employed as additional sensors to volumetrically extend the sensing zone, and is coupled with physically disturbing devices. A secondary sensor sends a signal to an associated physically disturbing device upon detecting an event to be monitored, and the signal operates the physically disturbing device to produce a physical disturbance that will be detected by the distributed sensor. Location of the event is identified by analyzing the disturbance and consequently by locating the physically disturbing device and the associated secondary sensor.

### CROSS-REFERENCE TO RELATED APPLICATION

This application claims the benefit of U.S. Provisional Application No. 60/674267, filed Apr. 22, 2005.

### BACKGROUND OF THE INVENTION

1. Field of the Invention

The present invention relates to an intrusion detection system that identifies location of intrusion over a volumetric zone. In particular, the invention relates to a distributed sensor system coupled with a plurality of secondary sensors deployed over a zone of detection, where activities or intrusions are monitored.

2. Description of the Related Art

Intrusion detection system provides information about intrusion or an event into a protected area or facility. Advanced detection system discreetly detects modest physical disturbances, and detects the location of the disturbance. Prior arts teach various distributed sensor technologies for detection and location of intrusion.

One of the available technologies is based on fiber optics, where physical disturbance alters attribute of light along an optical fiber, and the effect of the alteration is detected at the end of the optical fiber. British Patent No. 1,497,995 describes a fiber optic acoustic monitoring arrangement. U.S. Pat. No. 5,355,208 describes a distributed fiber optic sensing system for detecting mechanical, acoustic, or ultrasonic disturbances. U.S. Pat. No. 5,194,847 discloses apparatus and method for fiber optic intrusion sensing, and U.S. Pat. No. 6,813,403 describes a method for monitoring of large structure using Brillouin spectrum analysis to measure strain, displacement, temperature or other physical quantities at any location along an optical fiber attached to a structure. Our PCT application No. PCT/US05/11045 filed on Apr. 1, 2005 describes phase responsive optical fiber sensor to locate and detect an intrusion.

Another available technology for sensing other than fiber optics is described in, for an example, U.S. Pat. No. 5,446,446. These technologies have been used to create line sensors, referred to as sensor cables, transducer cables, or acoustic cables. Electrical signals or electromagnetic signals transmit along the cables mentioned above to detect intrusion. U.S. Pat. No. 5,446,446 describes intrusion detection system, where a radio frequency pulse is transmitted down the sensor cable, and the resulting received signals are processed to detect and precisely locate intruder-caused disturbances.

The distributed sensor forms a loop or a line to detect intrusion into the protected area, or is installed along side of a system that needs to be protected such as communication data link or pipeline. It is often necessary to extend the detection range to protect an area more securely or to collect additional information of intrusion that a distributed sensor would not provide. Existing distributed sensor system requires physical intrusion on the distributed sensor to detect the intrusion and to generate an alarm. Present invention provides an intrusion detection system that volumetrically extends the sensing range by employing a plurality of secondary sensors that is coupled with a distributed sensor system. An intrusion into the vicinity of the distributed sensor could be detected without physical intrusion on the distributed sensor by deploying secondary sensors in the vicinity of the distributed sensor. Present invention also extends the sensing capability in the form of information. Various forms of information could be obtained by employing various types of secondary sensors into the present invention.

The present invention described hereafter provides an intrusion detection system that effectively extends the range of detection, capable of locating an event over an extended volumetric zone, by employing a plurality of secondary sensors coupled to a distributed sensor system. Secondary sensors detect intrusion or other activities that are to be monitored. Physically disturbing devices are employed as connecting means between the secondary sensors and the distributed sensor, and are installed along the distributed sensor in the manner that could generate physical disturbance that properly disturbs the distributed sensor. Upon detecting intrusions, secondary sensors send signals to physically disturbing devices, and physically disturbing devices are operated to produce disturbed signals. The distributed sensor system detects and analyses the disturbed signals to identify the intrusion.

There are examples of physically disturbing devices in prior arts. U.S. Pat. No 5,355,208 discloses mechanical disturbing means, affixed to the fiber of a fiber optic sensor, for indicating system operability by deliberately agitating the fiber under control from a central system control station, and sound emitting means, carried on the person of an authorized individual, for transmitting a unique coded signal which is effectively to disturb the fiber optic sensor. The mechanical disturbing means and sound emitting means in the prior art are examples of physically disturbing devices that disturb the fiber of the fiber optic sensor that is a type of distributed sensor. U.S. Pat. No. 6,346,985 discloses a plurality of optical interferometers coupled to optical fibers and a plurality of electromechanical sensor arrays that are arranged to produce electrical signals in response to changes in a physical parameters being monitored, and are connected to one of the plurality of optical interferometers that produce phase difference signals in response to electrical signals produced by the electromechanical sensor arrays. Electromechanical sensor connected to an optical interferometer in the prior art is an example of a secondary sensor that is coupled to a device that could generate optically disturbed signals. In the present invention, distributed sensor is not only a transmitting means of optical or electrical signal, but also a sensor that could detect disturbances caused by intrusions. Physically disturbing devices employed in the present invention are required to be coupled with secondary sensors, capable of processing the signal sent from the secondary sensors.

### SUMMARY OF THE INVENTION

The present invention is an intrusion detection system comprising a distributed sensor, physically disturbing devices coupled with said distributed sensor, and a plurality of secondary sensors that are deployed over a zone of detection and coupled with said physically disturbing devices by the means of wired or wireless link.

The distributed sensor detects physical disturbance caused by intrusion. The distributed sensor detects mechanical, acoustic, or physical intrusion along its length distributed to protect an area. Advanced distributed sensor systems are capable of locating an event, while other types of distributed sensors only detect disturbance triggered by an intrusion. A distributed sensor employed in the present invention is not limited to a specific type of a distributed sensor, but it is necessary that the distributed sensor system has a capability to detect and to identify a physical disturbance caused by an intrusion.

The physically disturbing devices are coupled to the distributed sensor in a manner that physical disturbances produced by the physically disturbing devices properly disturb the distributed sensor, generating a disturbed signal along said distributed sensor so that the control station of said distributed sensor detect and further process the disturbed signals to determine locations of the physical disturbances. Said physically disturbing device is a mechanical vibrator, sound emitting means, thermal generator, or any type of means that produce physical disturbances that are properly and noticeably disturbing said distributed sensor.

The plurality of secondary sensors consists of a single or various types of sensors that are deployed over a zone of detection to monitor intrusion or other activities that are required to be detected. The secondary sensors provide the distributed sensor system with additional information, volumetrically extending the sensing area from that of the distributed sensor system. The plurality of secondary sensors in the present invention employs at least one secondary sensor. The plurality of secondary sensors is couple to the physically disturbing devices. Upon detecting an event, the secondary sensors send a signal to an associated physically disturbing device, operating the physically disturbing devices to properly disturb the distributed sensor. Each of the plurality of secondary sensors is coupled with at least one physically disturbing device. A sensor of said a plurality of secondary sensors is a motion sensing device, light sensing device, laser sensing device, or any type of sensing means that is designed for the purpose of monitoring the zone and is design to produce a signal as a result of sensing. The plurality of secondary sensors is coupled to physically disturbing devices by the means of a wired link or a wireless link

The purpose of the present invention is to volumetrically extend the sensing range and to improve sensing resolution by employing the plurality of secondary sensors. The system described in the present invention does not require multiple processing units to extend the detection area. One control station of the distributed sensor system manipulates information that is collected by the distributed sensor and the secondary sensors. Employing secondary sensors provides security personnel with flexibility in managing the security activity.

### BRIEF DESCRIPTION OF THE DRAWINGS

FIG. 1 is a schematic diagram of intrusion detection system with a distributed sensor system, physically disturbing devices, and a plurality of secondary sensors.

FIG. 2 is a schematic diagram showing a physically disturbing device coupled with a secondary sensor through wireless link. The secondary sensor is self-powered.

FIG. 3 is a schematic diagram showing a physically disturbing device coupled with a secondary sensor through a wireless link, but power is supplied from main power station.

FIG. 4 is a schematic diagram showing a physically disturbing device coupled with a secondary sensor through a wired link, but the secondary sensor is self-powered.

### DETAILED DESCRIPTION OF THE INVENTION

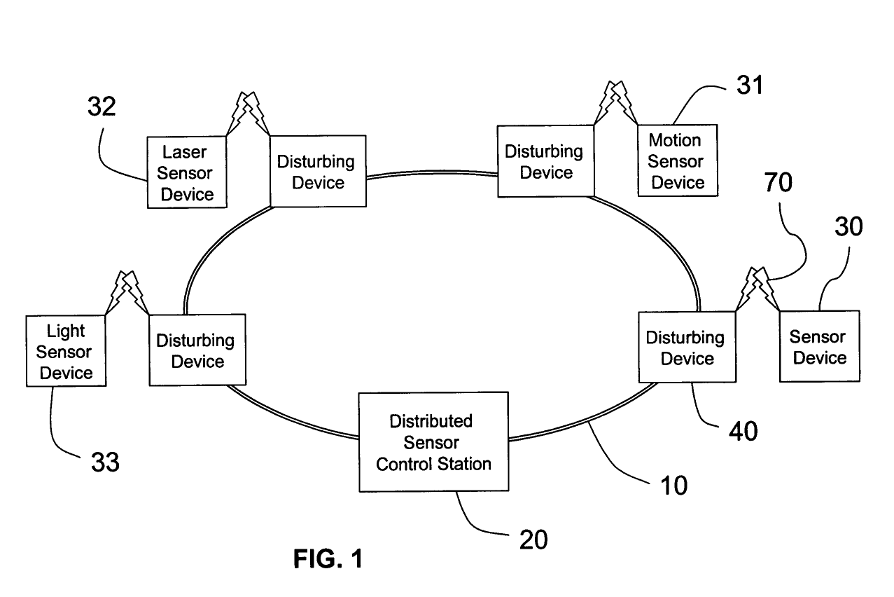

FIG. 1 shows a simplified schematic diagram of the intrusion detection system of the present invention. The invention relies on a distributed sensor system that consists of a distributed sensor 10 and a sensor control station 20. The system detects physical disturbance produced by an intrusion and generates a signal to trigger an alarm. One example of the distributed sensor is the phase responsive optical fiber sensor described in our PCT application PCT/US05/11045 filed on Apr. 1, 2005. In the distributed fiber sensor, optical waveguide such as optic fibers is used as a distributed sensor. In this example, optical signals are counter propagating through the optic fibers. When the distributed fiber sensor is disturbed, the physical disturbance of the sensor results in a change in the optical property of the optical signal that is propagating through the waveguide. Phase responsive receivers that are built in a distributed sensor control station 20 detect the changes of counter propagating optical signals and measure the time of arrival for each signal. A processor that is coupled with the phase responsive receiver determines the location of the disturbance from the time difference of arrivals of the changes of counter propagating signals. Phase responsive receiver and processor are built inside a distributed sensor control station 20, and are not shown in FIG. 1. The distributed fiber sensor is an example of the distributed sensors, and the distributed sensor of the present invention is not limited to a distributed sensor based on fiber optic technology.

A distributed sensor that is capable of detecting and identifying physical disturbances is employed into the present invention. Identifying the physical disturbance means that the distributed sensor has a capability to distinguish different patterns of physical disturbances. For an example, when a mechanical vibrator is affixed to a distributed sensor, and sequentially vibrates the sensor with different frequencies, it is required that the distributed sensor is able to detect the distinctive disturbances that are produced by different vibration frequencies. It is not necessary that the distributed sensor is able to measure the frequency, but it is necessary that the distributed sensor is able to identify distinctive patterns of disturbances. Examples of the distributed sensor that can be employed to the present invention are described in British Patent No. 1,497,995, U.S. Pat. No. 5,194,847, No. 5,355,208, No. 5,446,446, or No. 6,813,403.

The present invention extends the sensing range by deploying secondary sensors. FIG. 1 shows examples of the secondary sensors 30, 31, 32, and 33. The secondary sensor can be a motion detector, light sensing device, laser sensing device, or another type of sensor that generates a signal as a result of the detection. At least one secondary sensor is employed in the present invention.

Secondary sensors are coupled with physically disturbing devices 40 by the means of a wired or wireless link 70. Upon detecting an event or activity, the secondary sensor generates a signal and transmits the signal to a physically disturbing device through the wired or wireless link. Most of the secondary sensors available in the market are capable to be connected with a transmitter and a receiver as means of sending and receiving a signal. Wired or wireless link is a linking means that transmits a signal from a secondary sensor to physically disturbing device. Electrical wire or optical fiber could be an example of a wired link, while radio frequency or laser light could be an example of a wireless link. In the present invention, linking means includes a combination of wired links and wireless links, and includes a combination with other equipment such as amplifier to properly boost signal strength.

An example of the secondary sensors is a motion sensor device. A typical application of a motion sensor device is found in a lighting system installed in front of a building. When a motion sensor device detects moving object in front of the building, the device send a signal by a transmitter. While a type of motion sensing device uses electrical wire to transmit the signal to a receiver installed in the building, other type of motion sensing device transmits a radio frequency to the receiver. Upon receiving the signal, the receiver operates a switch integrated in an electrical circuit board of the light system to turn on lights installed in the building. In practical applications, the signal sent from a secondary sensor can be further manipulated for the purpose of a specific application. Printed circuit board or microprocessor could be designed and manufactured for the purpose of the application. In the present invention, the signals sent from secondary sensors are further processed to operate physically disturbing devices that are coupled to the distributed sensor.

When the secondary sensor is wirelessly linked with a physically disturbing device, it is necessary to characterize the signal by a unique code that is associated with the physically disturbing device. In this case, the physically disturbing device responds to the characteristic signal of predefined unique code and will not be interrupted by other signals sent from other secondary sensors. For examples, the characteristic signal could be generated with frequency division, time division, or code division multiplexing. One physically disturbing device may be coupled with one secondary sensor or with a plurality of secondary sensors depending on application and purpose of the detection.

When a physically disturbing device 40 receives a signal from a secondary sensor, the physically disturbing device properly disturbs the distributed sensor 10 in the manner that the disturbance will trigger an alarm for the distributed sensor system. The physically disturbing device is directly affixed on the distributed sensor, or is remotely installed in a manner that the device could make a type of disturbance that will properly trigger an alarm for the distributed sensor system. For an example, the physically disturbing device could be a mechanical vibrator affixed on a waveguide of the distributed fiber sensor or an acoustic transmitter installed near the distributed fiber sensor. The type of physically disturbing device depends on a type of distributed sensor, but it's required that the disturbing device is able to properly disturb the distributed sensor.

One embodiment of the present invention, illustrated in FIG. 1, employs a distributed sensor 10 that detects an event and is intrinsically able to locate the event. The process of detection is explained below by an example shown in FIG. 1. When a motion sensor device 31 detects a movement of an object, the device generates a signal and transmits the signal to a receiver of the sensor that operates to turn on a switch of a physically disturbing device 40. Upon turning on the switch, the physically disturbing device disturbs the distributed sensor 10 for a predetermined time period. The disturbance is detected in the control station 20 of the distributed sensor, and is processed to determine the location of the disturbance. Once the location is determined, the control station of the distributed sensor identifies the physically disturbing device that produced the disturbance. If one motion sensor is coupled with the physically disturbing device, the location of the object can be determined by identifying the position of the motion sensor device.

Another embodiment of the present invention, illustrated in FIG. 1, employs a distributed sensor 10 that is capable of detecting the location of an event and physically disturbing devices 40 that produce distinctive physical disturbances. Each physically disturbing device employed in this embodiment produces a characteristic disturbance that is characterized by a unique physical attribute of disturbance and is distinctive from disturbances produced by other physically disturbing devices. The characteristic disturbance is predefined by the nature and functionality of the employed distributed sensor, but is distinctive enough for the distributed sensor system to distinguish the disturbance from others. For an example, unique vibration frequency or vibration amplitude of a mechanical vibrator can be a characteristic disturbance of the vibrator.

Advantage of employing the characteristic disturbances into the physically disturbing devices is to improve an accuracy of determining the location of an event detected by a secondary sensor, and to discriminate the disturbance that is produced by a physically disturbing device from the disturbances that are produced by the distributed sensor itself. As described above, the distributed sensor itself is a sensor being capable of detecting intrusion occurred along the distributed sensor. In practical applications, the distribution sensor has a resolution in determining the location of an event. If a disturbance that is caused by an intrusion over the distributed sensor and the position of a physically disturbing device are within the range of the resolution, it is difficult to determine whether the disturbance is produced by a physically disturbing device or is produced by an intrusion over the distributed sensor. This difficulty would cause an error in determining the location of actual event. Employing characteristic disturbance into the physically disturbing device would reduce the error in locating an event.

Another embodiment of the present invention, illustrated in FIG. 1, employs physically disturbing devices 40 that produce characteristic physical disturbances and a distributed sensor 10 that is capable of detecting distinctive disturbance but is not able to locate an event. Prior arts disclose this type of distributed sensor. Despite the limited functionality of this type of distributed sensor, it has been known that different intrusion events produce different signal patterns having distinctive characteristics, and analysis of these distinct patterns can lead to identification of the source of the intrusion. When physically disturbing devices that produce distinctive characteristic physical disturbance are coupled with this type of distributed sensor, the identification of the characteristic disturbance makes it possible to identify the physically disturbing device that produces the characteristic disturbance.

For an example, a system may be built with a plurality of mechanical vibrators that is affixed to a distributed sensor, with each mechanical vibrator vibrating at a unique vibration frequency upon receiving a signal from a secondary sensor associated with the vibrator. Although the distributed sensor is not able to locate vibration position by detecting the disturbed signal, analyzing frequency of the disturbed signal leads to identify the vibrator, further leading to identify the secondary sensor associated with the vibrator and to locate the position of the event. A plurality of secondary sensors and physically disturbing devices characterized by a characteristic disturbance enables to extend the functionality of the distributed sensor.

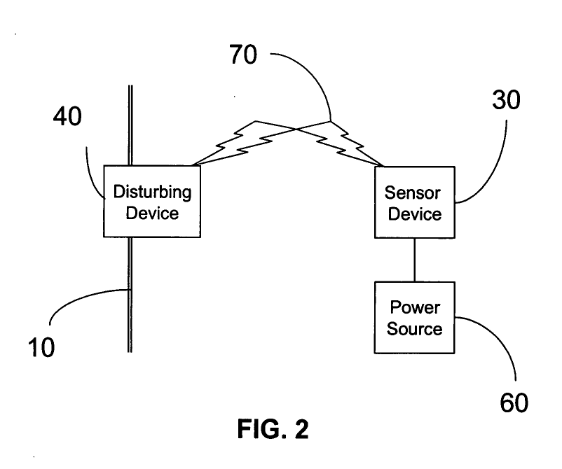

FIG. 2 shows an example of the present invention, where a secondary sensor 30 is coupled with a physically disturbing device 40 through wireless link 70. The wireless link is a type of linking means that could transmit signals without wire. For an example, the means of wireless link is a radio signal, laser signal, or acoustic signal. When the present invention employs more than one secondary sensor, the means of wireless link can be a plurality of means with various types of wireless link. For an example, wireless link of one secondary sensor is a radio signal, while wireless link of the other secondary sensor is a laser signal. A self-power generating means 60 is connected to the secondary sensor to supply necessary power to properly operate the devices, but the unit including secondary sensor and power source is separated from other means of the present invention. The self-power source is battery, solar cell, or a type of portable means of power supply that doesn't depend on a main power line of the system.

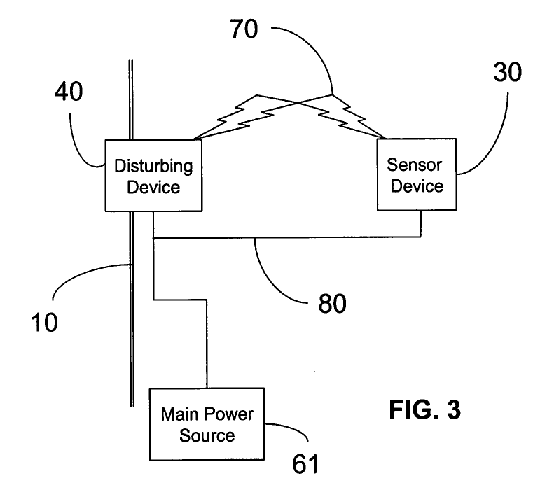

FIG. 3 shows an example of the present invention, where secondary sensor 30 is wirelessly coupled with a physically disturbing device 40 but power is supplied through a power cable 80 from a main power source 61 of the system that is not portable.

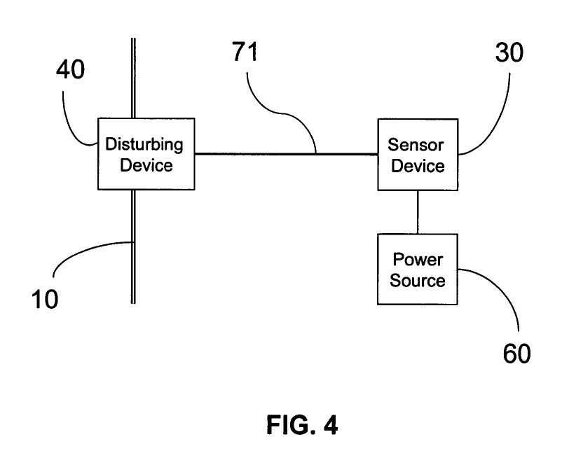

FIG. 4 shows an example of the present invention, where secondary sensor 30 is coupled with a physically disturbing device 40 with a wired link 71, but the secondary sensor is self powered.

FIGS. 2, 3, and 4 show examples of the embodiments of the present invention. However, it will be apparent to those skilled in the art that various arrangements, not shown in these examples, may be available based on the principles and concept of the present invention.

Advantage of the present invention is to provide flexibility in the management of the intrusion detection system. For an example, secondary sensors can be selected from a group of various types of sensing devices depending on purpose of the detection activity, while maintaining distributed sensor as a backbone structure of the detection system.

Another advantage of the present invention is capability of a portable system of location detection system. By deploying secondary sensors that are self powered and are wirelessly coupled with physically disturbing devices, detection area can be continuously switched from one area to the other area. This capability will help security personnel quickly respond to situations and increase mobility of detection activity.

Another advantage of the present invention is to provide more secure protection of the protected area. By deploying said secondary sensors near the distributed sensor, an attempt of intrusion or spying activity, such as surveillance activity along side of or around the distributed sensor, can be detected without direct physical intrusion into the distributed sensor.

The above description and disclosure of the present invention are illustrative of the preferred embodiments, and the present invention is not limited to the particular embodiments described by way of the examples.

What is claimed is:

1. An intrusion detection system comprising:
a distributed sensor system to detect physical disturbances caused by an intrusion over a distributed sensor of said distributed sensor system, said distributed sensor being deployed over a detection zone and producing a disturbance over said distributed sensor upon an intrusion;
a plurality of physically disturbing means for producing physical disturbances, coupled to said distributed sensor in a manner that each of said physically disturbing means disturbs said distributed sensor to produce a disturbance;
a plurality of secondary sensors deployed over a detection zone, each secondary sensor of said plurality of secondary sensors producing a signal in response to changes in a parameter being monitored by said secondary sensor; and
a linking means for transmitting signals produced by said secondary sensor to said physically disturbing means, said secondary sensor connected to at least one physically disturbing means of said plurality of physically disturbing means via said linking means.

2. The intrusion detection system of claim 1, wherein said distributed sensor system is intrinsically able to locate physical disturbances caused by an intrusion over said distributed sensor of said distributed sensor system.

3. The intrusion detection system of claim 1, further comprising a control station for detecting a disturbance and further processing said disturbance to detect and locate the intrusion.

4. The intrusion detection system of claim 1, wherein each of said physically disturbing means produces a characteristic physical disturbance that is identified at said distributed sensor system.

5. The intrusion detection system of claim 1, wherein each of said plurality of secondary sensors produces a characteristic signal, said characteristic signal being identified at least one of said plurality of physically disturbing means.

6. The intrusion detection system of claim 1, wherein said linking means is formed as a wired link.

7. The intrusion detection system of claim 1, wherein said linking means is formed as a wireless link.
